(19) United States
(12) Patent Application Publication
(10) Pub. No.: US 2012/0206273 A1
(43) Pub. Date: Aug. 16, 2012

(54) NETWORK SYSTEM AND METHOD OF CONTROLLING THE SAME

(75) Inventors: Yanghwan Kim, Seoul (KR); Hoonbong Lee, Seoul (KR); Koonseok Lee, Seoul (KR)

(73) Assignee: LG ELECTRONICS INC., Seoul (KR)

(21) Appl. No.: 13/502,005

(22) PCT Filed: Oct. 21, 2010
(86) PCT No.: PCT/KR2010/007231

§ 371 Date: Apr. 13, 2012

(30) Foreign Application Priority Data
Oct. 21, 2009 (KR) 10-2009-0100358

(51) Int. Cl. G08C 15/06

(52) U.S. Cl. 340/870.02

(57) ABSTRACT

Provided is a network system including an advanced metering infrastructure, an energy management system, a computer, and a diagnostic program. The advanced metering infrastructure interactively communicates with a power supply source and measures energy from the power supply source. The energy management system is connected to the advanced metering infrastructure to communicate with it and controls an operation of an electric product based on operation information of the electric product or energy information from the power supply source. The computer is connected to the electric product or energy management system to communicate with the electric product or energy management system. The diagnostic program is performed by the energy management system or computer and diagnoses a trouble of the electric product. An electric product having a trouble is remotely diagnosed to provide a quick countermeasure, thereby detecting the cause of the trouble without a service engineer and improving a user's convenience.

### TECHNICAL FIELD

The present disclosure relates to a network system and a method of controlling the network system.

### BACKGROUND ART

In general, power for operating electric products such as electric home appliances or office equipment is supplied through a power plant, a power transmission line, and a power distribution line.

Such power is supplied from a central power source, not a distributed power source, so that the power spreads in a radial shape from the center to the periphery, which is supplier-centered rather than consumer-centered. In addition, the supplying of the power is analog and electromechanical, and damage due to an accident is manually undone, and related facilities are manually recovered.

The information about electricity charge can be known only through a power exchange, and thus, it is difficult to know the information about electricity charge in real time. In addition, since a pricing system is substantially fixed, it is difficult to provide incentives for consumers by using price variations. To address these limitations and improve the efficiency of energy, research is being actively carried out on a smart grid.

The smart grid means the next generation power system and a management system thereof, which are realized by mixing and combining a modernized power technology and an information communication technology. A typical power grid is vertical and centralized network that is controlled by a supplier, but the smart grid is a horizontal, cooperative, and distributed network that is distributed from a supplier and allows the interaction between suppliers and consumers.

In the smart grid, all electric appliances, power storage devices, and distributed power sources are connected to one another through a network, so that suppliers can interact with consumers. Thus, the smart grid is referred to as an ‘energy Internet’. To realize the smart grid for power consumers such as a house or a building, it is needed that a separate electric product and a network connected to a plurality of electric products communicate with a power supply source through a two-way communication for power information, instead of just receiving power. Also, devices for the two-way communication are needed.

In addition, a method of controlling an electric product is needed, which can analyze an electricity charge in real time when the electric product is used, and can suppress the using of the electric product in a time period when an electricity price is high, thereby saving energy and electricity costs.

When an electric product connected to a related art network has a trouble, it is difficult for a user to check the trouble and inform a service center of the trouble, and a service engineer's help is needed. Thus, time and costs for repairing and recovering the product are required.

### DISCLOSURE OF INVENTION

### Technical Problem

Embodiments provide a network system and a method of controlling the network system, which use a power network system to remotely diagnose an electric product having an operation trouble thus providing a quick countermeasure, thereby improving a user's convenience.

Embodiments also provide a network system and a method of controlling the network system, which download a new upgraded operation program through a communication network, thereby providing an improved operation mode to a user.

### Solution to Problem

In one embodiment, a network system includes: an advanced metering infrastructure interactively communicating with a power supply source and measuring energy supplied from the power supply source; an energy management system connected to the advanced metering infrastructure to communicate with the advanced metering infrastructure and controlling an operation of an electric product based on information about the operation of the electric product or energy information supplied from the power supply source, a computer connected to the electric product or the energy management system to communicate with the electric product or the energy management system; and a diagnostic program that is performed by the energy management system or the computer and diagnoses a trouble of the electric product.

In another embodiment, a network system includes: an advanced metering infrastructure communicating with a power supply source and measuring energy supplied from the power supply source; an energy management system connected to the advanced metering infrastructure to communicate with the advanced metering infrastructure and controlling an operation of an electric product based on information about the operation of the electric product or energy information supplied from the power supply source; and a service center connected to the energy management system to communicate with the energy management system and remotely diagnosing a trouble of the electric product.

In further another embodiment, a method of controlling a network system includes: recognizing an anomaly of an electric product in operation; primarily diagnosing operation information of the electric product through a diagnostic program; transmitting the operation information of the electric product to a service center, based on a result of the diagnosing through the diagnostic program; and secondarily diagnosing the anomaly of the electric product at the service center.

The details of one or more embodiments are set forth in the accompanying drawings and the description below. Other features will be apparent from the description and drawings, and from the claims.

### Advantageous Effects of Invention

According to the embodiment, the power network system is used to remotely diagnose an electric product having an operation trouble thus providing a quick countermeasure, thereby detecting the cause of the trouble without a service engineer's help and improving a user's convenience.

In addition, a new upgraded operation program can be downloaded through the communication network, thereby satisfying a user and efficiently driving an electric product.

### BRIEF DESCRIPTION OF DRAWINGS

FIG. 1 is a schematic view illustrating a smart grid according to an embodiment.

FIG. 2 is a schematic view illustrating a network system according to an embodiment.

FIG. 3 is a front view illustrating an energy management system (EMS) according to an embodiment.

FIG. 4 is a block diagram illustrating a control of a network system according to an embodiment.

FIGS. 5 and 6 are flowcharts illustrating a method of controlling a network system according to an embodiment.

### MODE FOR THE INVENTION

Reference will now be made in detail to the embodiments of the present disclosure, examples of which are illustrated in the accompanying drawings.

All terms used herein have the same meanings as general terms understood by those of ordinary skill in the art. If the terms used herein collide with the general terms, the terms used herein take priority over the general terms. While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

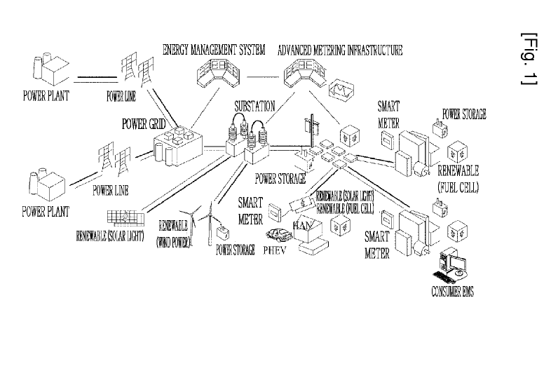

FIG. 1 is a schematic view illustrating a smart grid according to an embodiment.

Referring to FIG. 1, the smart grid includes a power plant generating energy (electricity) by thermal power generation, nuclear power generation, or water power generation; and a solar power plant and a wind power plant that generate electricity from renewable energy sources such as solar light and wind power.

The power plant, such as a thermal power plant, a nuclear power plant, and a water power plant, supplies electricity to a sub-control center through a power line, and the sub-control center supplies the electricity to a substation where the electricity is distributed to consumers such as residential customers or offices.

Electricity generated from renewable energy sources is delivered to the substation where the electricity is distributed to consumers. Electricity transmitted from the substation is distributed to consumers such as offices and residential customers through power storages.

Residential customers using a home area network (HAN) may produce electricity by using a solar battery or fuel cells of a plug in hybrid electric vehicle (PHEV) for their own use or selling the remaining electricity.

Energy generated from the power plant, renewable energy, or in-house energy may be referred to as an ‘energy supply source’.

In addition, since smart metering devices are provided to consumers such as offices or residential customers, power consumption or electricity bills can be checked in real time, and thus the consumers can take action to reduce power consumption or electricity costs based on the real-time information about power consumption and electricity bills.

Furthermore, since the power plants, the sub-control center, the power storages, and the consumers can communicate with each other (two-way communication), electricity is not transmitted to the consumers unilaterally but generated and distributed to the consumers according to the consumers' situations notified to the power storages, the sub-control center, and the power plants.

In such a smart grid, an energy management system (EMS) plays a pivotal role for real-time power line communication with a consumer, and an advanced metering infrastructure (AMI) plays a pivotal role for real-time power consumption measurement.

The AMI of the smart grid is backbone technology for integrating consumers based on an open architecture. The AMI provides consumers with the ability to use electricity efficiently and power providers with the ability to detect problems on their systems and operate them efficiently.

Herein, the open architecture means a standard for connecting all electric products in a smart grid system regardless of the manufactures of the electric products, unlike in a general communication network. Therefore, the AMI of the smart grid enables consumer-friendly efficiency concepts like “prices to devices.”

That is, real-time price information of an electricity market may be displayed on an EMS of each residential customer, and the EMS may control electric products while communicating with the electric products. Thus, a user may see the information displayed on the EMS to check energy (power) information of each electric product and carry out power information processing such as power consumption limit setting or electricity charge limit setting to save energy and reduce costs.

The EMS may include local EMSs provided in offices or residential customers, and a central EMS configured to process information collected from the local EMSs through two-way communication.

Since real-time communication is possible between providers and consumers in a smart grid for exchanging power information, real-time grid response can be realized, and costs necessary for meeting a peak demand can be reduced.

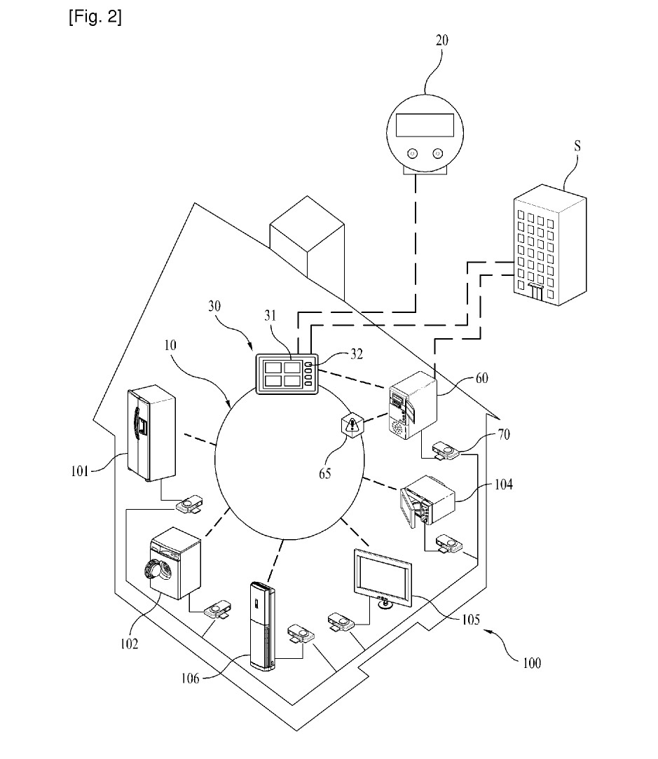

FIG. 2 is a schematic view illustrating a network system according to an embodiment, in which the network system is a power supply network system 10 of a residential customer as a main consumer of power.

The power supply network system 10 includes: an advanced metering infrastructure (smart meter) 20 which can measure power, an electricity charge, and a power consumption peak time period supplied to a residential customer and the electricity charge of the power in real time; and an energy management system (EMS) 30 connected to the advanced metering infrastructure (smart meter) 20 and a plurality of electric products such as home appliances for controlling the electric products. The power consumption peak time period is a period when the power consumption and electricity charge are higher than at any other time of day.

The EMS 30 may be provided in the form of a terminal, which includes a screen 31 to display the current power consumption state and external environments (temperature, humidity) and an input unit 32 to receive user's manipulations.

The EMS 30 is connected to an electric product 100 such as a refrigerator 101, a washing or drying machine 102, an air conditioner 103, a TV 105, and a cooking appliance 104 through an in-house network for two-way communication.

In-house communication may be performed by wireless or power line communication (PLC), and electric home appliances may be connected to each other for communicating with each other.

Aside from the EMS 30, a computer 60 that can perform a communication through the Internet is provided. The computer 60 can communicate with the electric products. In detail, the computer 60 can communicate with the electric products through a predetermined communication device 65 such as a black box, so that, operation information of the electric products may be transmitted to the computer 60 or predetermined data may be transmitted from the computer 60 to the electric product.

The electric products 100 and the computer 60 are provided with a memory port, so that, a memory 70 can be selectively coupled to the electric products 100 and the computer 60. The memory 70 may include an USB memory.

The memory 70 is inserted in the electric product 100, then, operation information of the electric product 100 is stored in the memory 70, and then, the memory 70 is removed and inserted to the computer 60, so that the operation information can be stored in the computer 60. The operation information may include an interaction state between components constituting a network, and power information such as a power supply state.

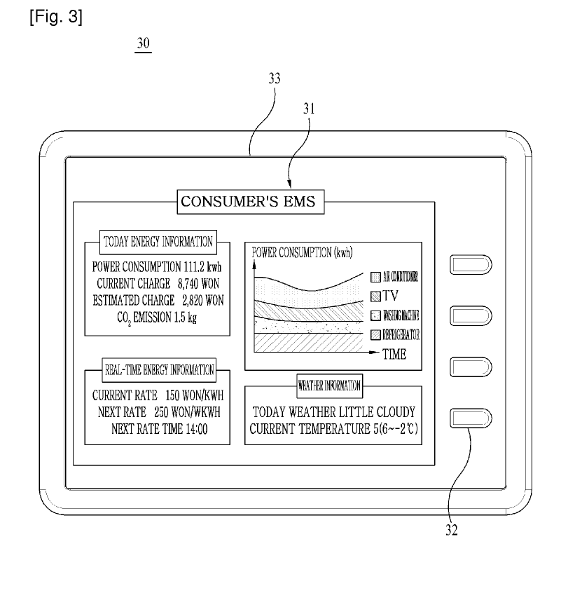

FIG. 3 is a view illustrating an energy management system (EMS) according to an embodiment. Referring to FIG. 3, the EMS may be a terminal including a touch panel 33.

A screen 31 may be displayed on the touch panel 33 to provide energy information such as an electricity consumption amount, an electricity charge, an electricity charge estimated based on an accumulated consumption history, and a carbon dioxide emission amount; and/or additional information such as weather information.

The electricity consumption amount or the electricity charge may be provided as real time information, accumulated information, or current time period information or the next time period information within a preset time period.

The screen 31 may include a graph illustrating power consumption amounts and variations thereof according to time periods of each electric product. A button part 32 may be disposed at a side of the screen 31 to set an operation of an electric product according to a user's requirement.

A user uses 32 uses the button part 32 to set a limit of a power amount or an electricity charge of each electric home appliance, and thus, the EMS 30 can control the operation of each electric home appliance according to the setting.

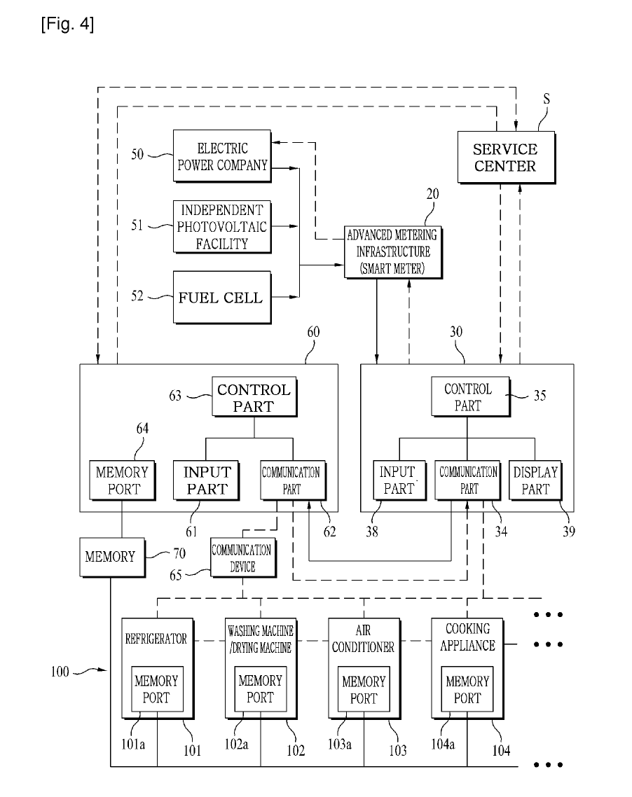

FIG. 4 is a block diagram illustrating a control between a power supply source under a smart grid, a control of a network system that is in charge of supplying power to an electric product in home, and a service center S providing a remote diagnosis and a countermeasure of the electric product.

Referring to FIG. 4, the power supply source may an electric power company 50 including typical generating equipment (thermal power, nuclear power, and water power) or generating equipment using renewable energy (solar light, wind power, and terrestrial heat). In addition, the power supply source may include an independent photovoltaic facility 51 that can be provided to each residential customer, and a fuel cell 52 that can be provided to a fuel cell vehicle or a residential customer.

The power supply source is connected to the advanced metering infrastructure (smart meter) 20, and the advanced metering infrastructure 20 is connected to the EMS 30.

The EMS 30 may include a control part 35, an input part 38, a communication part 34, and a display part 39.

The communication part 34 communicates with the electric product 100 in home, such as a refrigerator 101, a washing/drying machine 102, an air conditioner 103, and a cooking appliance 104 to transmit and receive power information and driving information thereof.

The control part 35 analyzes set information input by a user using the input part 38, previously accumulated history information about the operation of electric products and power usage, and the amount of power supplied from the outside. Then, the control part 35 processes the information to control the operations or power of the electric products.

The computer 60 is provided with an input part 61 such as a keyboard, a communication part 62 communicating with the electric product 100 through a wireless channel, and a memory port 64.

A communication device 65 that relays the communication between the computer 60 and the electric product 100 is provided separately from the computer 60 to transmit a file or data between the computer 60 and the electric product 100 through two-way communication. The communication device 65 may be a black box.

The memory 70 such as an USB memory may be removably coupled to the memory port 64 of the computer 60 and memory ports 101a, 102a, 103a, and 104a provided to the electric products 100. Operation or energy information of the electric product 100 may be stored in the memory 70, and be transferred to the computer 60 through the memory 70. Information stored in the computer 60 may be transferred to the electric product 100 through the memory 70. That is, operation or energy information of the electric product 100 is stored in the memory 70, and then, the memory 70 can be transferred to both the computer 60 and the electric product 100.

The computer 60 or the EMS 30 stores a self-diagnostic program that analyzes the reason of an operation trouble of an electric product, based on operation information of the electric product, and provides a countermeasure thereof.

The self-diagnostic program may be provided to a web page on the Internet. Operation information of an intended electric product may be uploaded to the web page and be analyzed to obtain the reason of an operation trouble and a countermeasure thereof. In this case, the countermeasure is disposed within a scope where a user can repair the electric product on his/her own without any service engineer's help.

The computer 60 and the EMS 30 are connected to the service center S through the wire/wireless Internet to transmit operation information or other data of the electric product, stored in the computer 60 or the EMS 30, to a service center.

In addition, the latest operation program provided by service center is downloaded and transferred to the electric product 100 to operate the electric product 100 according to a new operation mode.

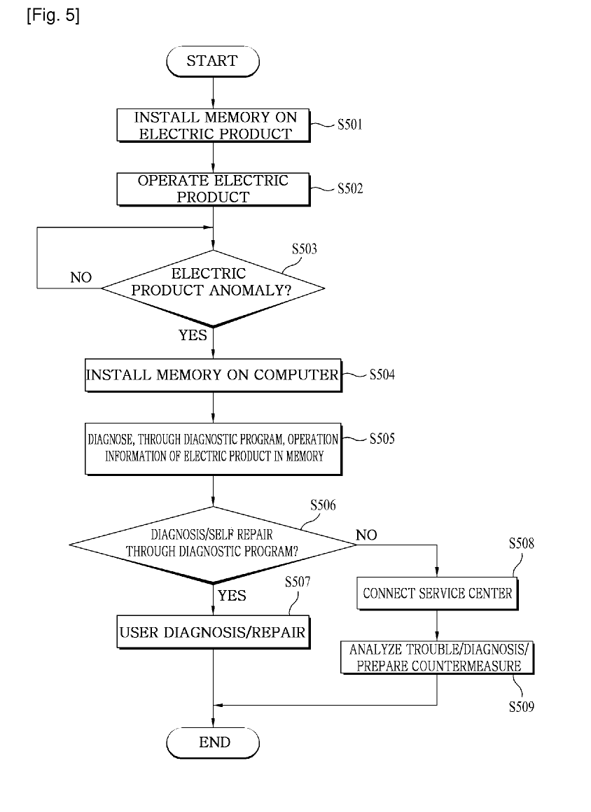

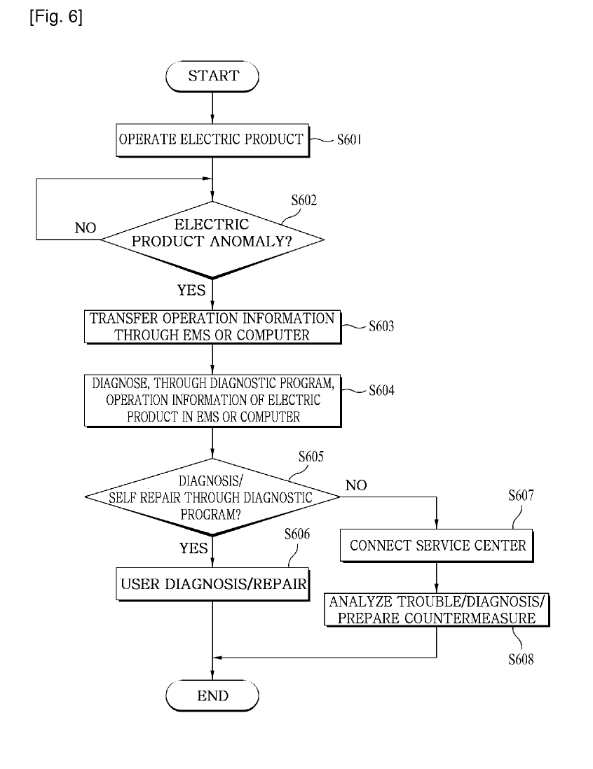

Hereinafter, a control flow according to an embodiment will now be described with reference to the accompanying drawings. FIGS. 5 to 6 are flowcharts illustrating a method of controlling a network system according to an embodiment.

First, a method of diagnosing operation information of an electric product and preparing a countermeasure thereof by using a memory will now be described. As illustrated in FIG. 5, the memory is installed on the electric product in operation S501, and the electric product is operated in operation S502.

In this state, when an anomaly (trouble) of the electric product is found in operation S503, operation information about the anomaly is stored in the memory, and then, the memory is installed on a computer in operation 504. In operation S505, the operation information of the electric product stored in the memory is copied to the computer, and then, is diagnosed by a diagnostic program. The diagnostic program may be an application program installed within the computer, or a program uploaded on an Internet web site.

When the diagnostic program is a program uploaded on an Internet web site, the operation information created in the form of a file is uploaded on the web site, and then, the diagnostic program is activated to find the reason of the anomaly and the countermeasure (primary diagnosis).

While the operation information is diagnosed by the diagnostic program, it is determined whether the reason of the anomaly and the countermeasure are present in operation S506. If the reason of the anomaly can be analyzed, and the countermeasure for the user to remove the anomaly can be provided, the user diagnoses the operation information on his/her own and repairs the electric product in operation S507.

If it is determined that the diagnosis using the diagnostic program and the preparation of the countermeasure are difficult, a communication with a service center is performed in operation S508, and the service center receives the operation information from the computer through the Internet, and analyzes and diagnoses the operation information (secondary diagnosis) to provide a countermeasure against the anomaly. A result of the diagnosis at the service center or the countermeasure may be transferred to the EMS or the computer in operation S509.

Referring to FIG. 6, a process of providing operation information and diagnosing a trouble by using the EMS or the computer will now be described.

While an electric product operates in operation S601, if an anomaly (trouble) of the electric product is detected in operation S602, the EMS or the computer communicates with the electric product, so that, operation information of the electric product is transmitted to the EMS or the computer in operation S603.

In operation S604, the EMS or the computer uses a diagnostic program that is set in the EMS or the computer to diagnose the operation information of the electric product. As described above, the diagnostic program may be an application program installed within the computer, or a program uploaded on an Internet web site.

While the operation information is diagnosed by the diagnostic program, it is determined whether the reason of the anomaly and a countermeasure are present in operation S605. If the reason of the anomaly can be analyzed, and the countermeasure for the user to remove the anomaly can be provided, the user diagnoses the trouble on his/her own and repairs the electric product in operation S606.

If it is determined that the diagnosis using the diagnostic program and the preparation of the countermeasure are difficult, a communication with a service center is performed in operation S607. The service center receives the operation information from the computer through the Internet, and analyzes and diagnoses the operation information to provide a countermeasure against the anomaly in operation S608.

Under the configuration as illustrated in FIG. 4, an upgraded operation program of a predetermined electric product may be downloaded from the service center, and be activated in the electric product.

To this end, the computer or the EMS may download the upgraded operation program provided by the service center. Then, the downloaded operation program may be transmitted to the electric product through a wireless communication or the memory.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The monitoring system according to the embodiment uses the power network system to remotely diagnose an electric product having an operation trouble thus providing a quick countermeasure, thereby detecting the cause of the trouble without a service engineer's help and improving a user's convenience.

1. A network system comprising:
an advanced metering infrastructure interactively communicating with a power supply source and measuring energy supplied from the power supply source;
an energy management system connected to the advanced metering infrastructure to communicate with the advanced metering infrastructure and controlling an operation of an electric product based on information about the operation of the electric product or energy information supplied from the power supply source,
a computer connected to the electric product or the energy management system to communicate with the electric product or the energy management system; and
a diagnostic program that is performed by the energy management system or the computer and diagnoses a trouble of the electric product.

2. The network system according to claim 1, further comprising a service center that is connected to the computer or the energy management system to communicate with the computer or the energy management system and diagnoses an anomaly of the electric product based on operation information of the electric product.

3. The network system according to claim 2, wherein the service center transfers a result of the diagnosing of the anomaly of the electric product or a countermeasure thereof to the computer or the energy management system.

4. The network system according to claim 2, wherein when it is determined that the trouble of the electric product is not removed by the diagnostic program, the service center diagnoses the trouble.

5. The network system according to claim 1, wherein the diagnostic program is provided to the energy management system, the computer, or an internet.

6. The network system according to claim 1, further comprising a memory that is removably installed on the electric product or the computer and stores operation information of the electric product.

7. The network system according to claim 6, wherein when the memory is installed on the computer, the operation information of the electric product is diagnosed by the diagnostic program.

8. The network system according to claim 1, wherein operation information of the electric product is transmitted to the energy management system or the computer, and the transmitted operation information is diagnosed by the diagnostic program.

9. A network system comprising:
an advanced metering infrastructure communicating with a power supply source and measuring energy supplied from the power supply source;
an energy management system connected to the advanced metering infrastructure to communicate with the advanced metering infrastructure and controlling an operation of an electric product based on information about the operation of the electric product or energy information supplied from the power supply source; and
a service center connected to the energy management system to communicate with the energy management system and remotely diagnosing a trouble of the electric product.

10. The network system according to claim 9, further comprising a computer configured to store operation information of the electric product.

11. The network system according to claim 10, further comprising a memory that is removably coupled to the computer and transfers the operation information of the electric product to the computer.

12. The network system according to claim 10, further comprising a diagnostic program using the operation information of the electric product to diagnose a trouble of the electric product, wherein the diagnostic program is stored in one of the energy management system, the computer, and a web page of an internet.

13. A method of controlling a network system, the method comprising:
recognizing an anomaly of an electric product in operation;
primarily diagnosing operation information of the electric product through a diagnostic program;
transmitting the operation information of the electric product to a service center, based on a result of the diagnosing through the diagnostic program; and
secondarily diagnosing the anomaly of the electric product at the service center.

14. The method according to claim 13, wherein the diagnostic program is stored in at least one of an energy management system controlling an operation of the electric product, a computer, and a web page of an internet, and the computer and the web page store the operation information of the electric product.

15. The method according to claim 14, wherein when an anomaly of the electric product is recognized, the operation information of the electric product is transferred to the energy management system, the computer, or the web page through a memory or a set communication method.

16. The method according to claim 13, wherein when a self diagnosis of the electric product is impossible according to the result of the diagnosing through the diagnostic program, the operation information of the electric product is transferred to the service center.
